(19) United States
(12) Patent Application Publication
(10) Pub. No.: US 2012/0169493 A1
(43) Pub. Date: Jul. 5, 2012

(54) MOBILE STORAGE DEVICE WITH ALARM FUNCTION

(75) Inventor: JUI-KUN HSIEH, Tu-Cheng (TW)

(73) Assignee: HON HAI PRECISION INDUSTRY CO., LTD., Tu-Cheng (TW)

(21) Appl. No.: 12/982,912

(22) Filed: Dec. 31, 2010

(30) Foreign Application Priority Data
Dec. 30, 2010 (TW) 99146848

(51) Int. Cl. G08B 21/00

(52) U.S. Cl. 340/540

(57) ABSTRACT

A mobile storage device includes a connector to be electrically connected to a computer, a storage unit, a microcontroller, and an alarm unit. The microcontroller controls the storage unit to store data from the computer or controls the storage unit to output data to the computer. The alarm unit is electrically connected to the microcontroller. The storage unit stops working after all data is transmitted or received. The microcontroller detects that the storage unit stops working and outputs a control signal to control the alarm unit to output an alarm signal.

### BACKGROUND

1. Field of the Invention

The present disclosure relates to a mobile storage device.

2. Description of Related Art

With development of computer technologies, mobile storage devices, such as universal serial bus (USB) memory sticks, are widely used. These mobile storage devices capable of being quickly plugged in a computer are convenient to be used, but it is easily forgotten to be unplugged from the computer because of small sizes. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a mobile storage device with alarm function in accordance with an exemplary embodiment of the present disclosure.

FIG. 2 is a schematic diagram of the mobile storage device of FIG. 1 in accordance with a first exemplary embodiment of the present disclosure.

FIG. 3 is a schematic diagram of the mobile storage device of FIG. 1 in accordance with a second exemplary embodiment of the present disclosure.

### DETAILED DESCRIPTION

The disclosure, including the drawings, is illustrated by way of examples and not by limitation. It should be noted that references to “an” or “one” embodiment in this disclosure are not necessarily to the same embodiment, and such references mean at least one.

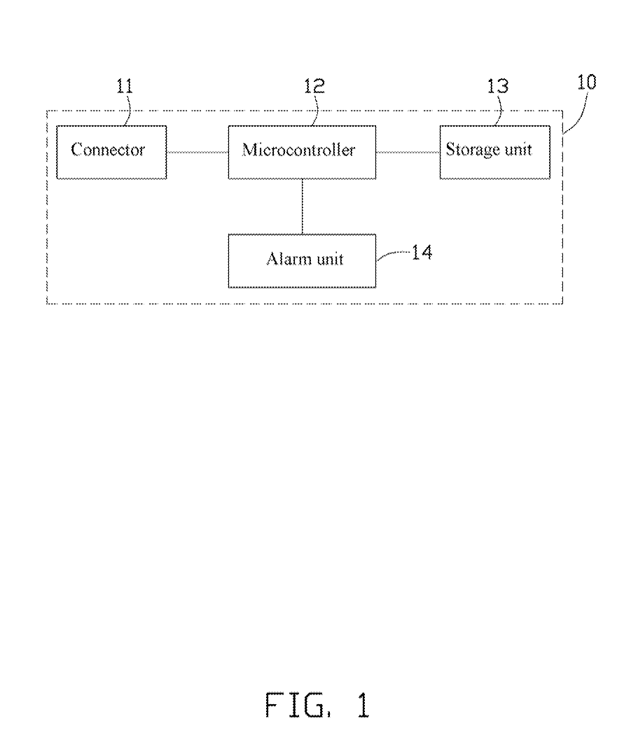

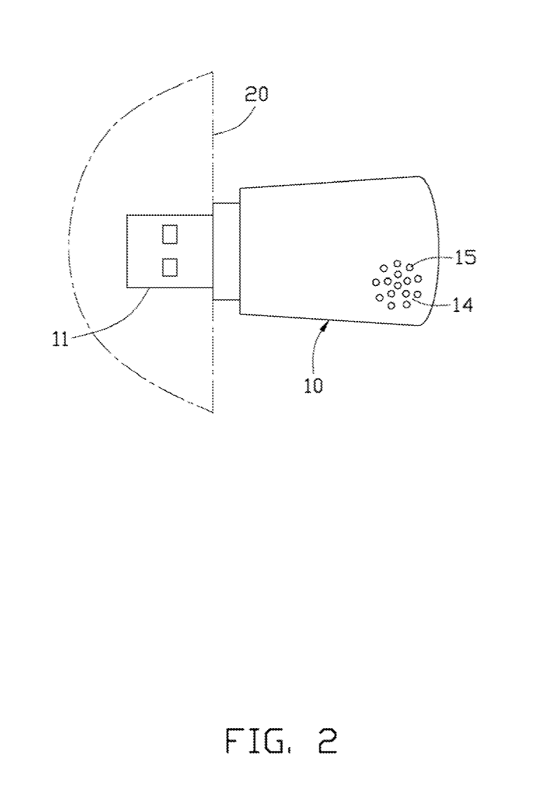

Referring to FIGS. 1 and 2, a mobile storage device 10 in accordance with a first exemplary embodiment includes a connector 11, a microcontroller 12, a storage unit 13, and an alarm unit 14.

The connector 11 is configured to be electrically connected to a connector (not shown) of a computer 20. The microcontroller 12 is configured to control the storage unit 13 to store data from the computer 20 or control the storage unit 13 to output data to the computer 20. The alarm unit 14 is electrically connected to the microcontroller 12, to be controlled by the microcontroller 12 to output an alarm signal. In the first embodiment, the alarm unit 14 is a buzzer. A plurality of through holes 15 is defined in the mobile storage device 10 and aligned with the buzzer.

When the mobile storage device 10 is connected to the computer 20 through the connector 11, the computer 20 identifies the mobile storage device 10. The storage unit 13 outputs data to the computer 20 or stores data from the computer 20. The storage unit 13 stops working after all data is transmitted or received. If the mobile storage device 10 does not be removed from the computer 20, the microcontroller 12 detects that the storage unit 13 stops working and outputs a control signal to the buzzer for controlling the buzzer to output an alarm sound, to remind a user to remove the mobile storage device 10 from the computer 20.

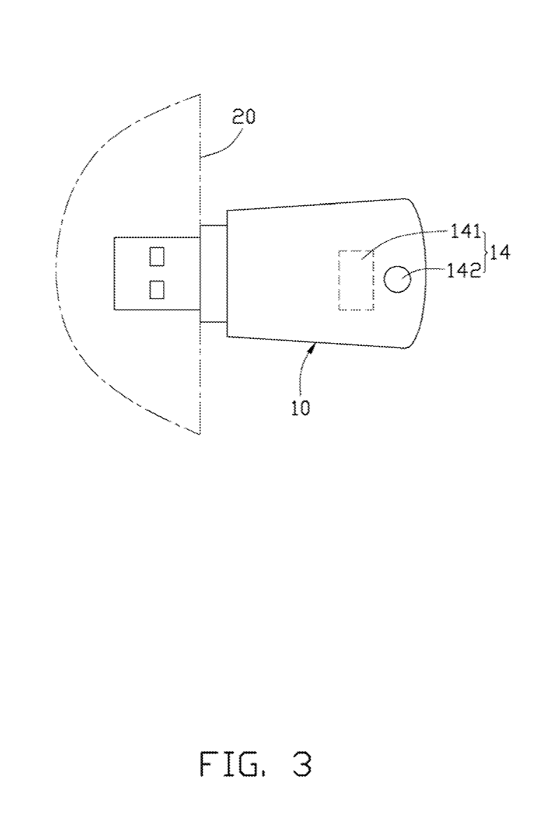

Referring to FIG. 3, a difference between the mobile storage device 10 of the first embodiment and a second embodiment is that the alarm unit 14 includes a power circuit 141 and a light emitting diode (LED) 142 in the second embodiment.

When the microcontroller 12 detects that the storage unit 13 stops working after all data is transmitted or received, the microcontroller 12 controls the power circuit 141 to trigger the LED 142 to light, to remind the user to remove the mobile storage device 10 from the computer 20.

The alarm unit 14 may be a music chip. When the microcontroller 12 detects that the storage unit 13 stops working after all data is transmitted or received, the microcontroller 12 outputs a control signal to control the music chip to play music, to remind the user to remove the mobile storage device 10 from the computer 20.

The mobile storage device 10 with alarm function can output an alarm signal, such as sound, light, or music to remind a user to remove the mobile storage device 10 from the computer 20 after all data is transmitted or received.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile storage device with alarm function, the mobile storage device comprising:
a connector to be electrically connected to a computer;
a storage unit to store data;
a microcontroller to control the storage unit to store data from the computer or control the storage unit to output data to the computer; and
an alarm unit to be electrically connected to the microcontroller;
wherein the storage unit stops working after all data is transmitted or received, the microcontroller detects that the storage unit stops working and outputs a control signal to control the alarm unit to output an alarm signal.

2. The mobile storage device of claim 1, wherein the alarm unit comprises a power circuit and a light emitting diode (LED), the microcontroller controls the power circuit to trigger the LED to light when the microcontroller detects that the storage unit stops working.

3. The mobile storage device of claim 1, wherein the alarm unit is a buzzer, a plurality of through holes is defined in the mobile storage device, aligned with the buzzer, the microcontroller controls the buzzer to output an alarm sound after the microcontroller detects that the storage unit stops working.

4. The mobile storage device of claim 1, wherein the alarm unit is a music chip, the microcontroller controls the music chip to play music after the microcontroller detects that the storage unit stops working.
